(19) United States
(12) Patent Application Publication
(10) Pub. No.: US 2024/0165749 A1
(43) Pub. Date: May 23, 2024

(54) APPARATUS AND METHOD FOR MONITORING LASER POWER

(71) Applicant: TRUMPF Laser GmbH, Schramberg (DE)

(72) Inventors: Hanspeter Erchinger, St. Georgen (DE); Thomas Notheis, Schramberg (DE)

(21) Appl. No.: 18/429,488

(22) Filed: Feb. 1, 2024

Related U.S. Application Data
(63) Continuation of application No. PCT/EP2022/070010, filed on Jul. 18, 2022.

(30) Foreign Application Priority Data
Aug. 5, 2021 (DE) 10 2021 120 400.3

(51) Int. Cl. B23K 37/00; B23K 26/70

(52) U.S. Cl. CPC B23K 37/006; B23K 26/707

(57) ABSTRACT

A laser installation includes a laser, a laser machining unit, and a safety controller. The laser is configured to provide laser light to the laser machining unit. A laser power of the laser light is variable. The safety controller is communicatively connected to the laser and the laser machining unit. The laser and/or the laser machining unit is configured to transmit at least one parameter value relating to the laser power to the safety controller. The safety controller is configured to compare the at least one parameter value with a limit value, and turn off the laser or block the laser light upon determining that the at least one parameter value exceeds the limit value.

### CROSS REFERENCE TO RELATED APPLICATIONS

This application is a continuation of International Application No. PCT/EP2022/070010 (WO 2023/011898 A1), filed on Jul. 18, 2022, and claims benefit to German Patent Application No. DE 10 2021 120 400.3, filed on Aug. 5, 2021. The aforementioned applications are hereby incorporated by reference herein.

### FIELD

Embodiments of the present invention relate to a laser installation having a safety controller, and to a method for monitoring laser power.

### BACKGROUND

DE 10 2011 085 593 A1 has disclosed a laser installation having a laser, a laser machining unit and a safety controller.

### SUMMARY

Embodiments of the present invention provide a laser installation. The laser installation includes a laser, a laser machining unit, and a safety controller. The laser is configured to provide laser light to the laser machining unit. A laser power of the laser light is variable. The safety controller is communicatively connected to the laser and the laser machining unit. The laser and/or the laser machining unit is configured to transmit at least one parameter value relating to the laser power to the safety controller. The safety controller is configured to compare the at least one parameter value with a limit value, and turn off the laser or block the laser light upon determining that the at least one parameter value exceeds the limit value.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a laser installation according to an embodiment of the invention; and

FIG. 2 shows a further laser installation according to an embodiment of the invention.

### DETAILED DESCRIPTION

Embodiments of the invention provide an apparatus and a method, which can improve the safety of laser installations.

According to embodiments of the present invention, a laser installation, in particular a laser network, having at least a laser and having at least a laser machining unit and at least a safety controller, the laser being provided and configured to send a laser light to the laser machining unit, the safety controller being communicatively connected to the laser and the laser machining unit, wherein the laser is provided and configured to vary an emitted laser power, the laser and/or the laser machining unit being provided and configured to transmit at least one parameter value relating to the laser power to the safety controller, the safety controller being provided and configured to compare at least the parameter value with a limit value and to turn off the laser or block the laser light if the limit value is violated.

The laser light can be sent from the laser to the laser machining unit for example via a laser light cable or a fixed tubing or as a free beam.

It is understood that the phrase switching off the laser or blocking the laser light includes the laser being switched off and the laser light being blocked. The safety is increased further by combining the measures. In particular, this prevents laser light from being sent to the laser machining unit if the implementation of one of the measures fails.

For example, blocking the laser light can be achieved by virtue of the laser light being steered to an absorber within the laser.

The laser creates a laser light with a variable laser power. This laser light is sent to the laser machining unit via a laser light cable. The safety controller monitors the laser power by the comparison of at least one parameter relating to the laser power with a limit value and ensures that the laser is switched off or the laser light is blocked if the parameter violates the limit value.

Embodiments of the invention can be used in laser networks in particular. In a laser network, a laser is able to send laser light to a plurality of laser machining units via laser light cables. In this case, each laser machining unit is preferably assigned a safety controller.

The safety controller is preferably designed redundantly, in particular in the form of two programmable logic controllers, with preferably each programmable logic controller comparing a different parameter value with the limit value. The redundant design makes it possible to identify whether one of the redundant controllers has failed. The laser is switched off or the laser light is blocked in this case. For example, field-programmable gate arrays (FPGAs), application-specific integrated circuits (ASICs) or processors may also be used instead of programmable logic controllers (PLCs).

Preferably, the redundantly embodied safety controller comprises a plurality of execution units and is designed for a cross comparison between the execution units. Faults in a safety controller can be identified by means of a cross comparison. The laser is switched off or the laser light is blocked if such a fault is identified.

Preferably, the limit value is permanently programmed in the safety controller. A faulty configuration of the safety controller is avoided as a result of permanent programming of the limit value. Permanent programming is possible, in particular, in the case of programmable logic controllers (PLCs), field-programmable gate arrays (FPGAs) and application-specific integrated circuits (ASICs).

Preferably, the laser machining unit is provided and configured to transmit a requested laser power as parameter value. The laser machining unit requests a laser power from the laser. The value of the laser power requested is transmitted to the safety controller. If the requested laser power is greater than the limit value, then this is assessed as a violation of the limit value by the safety controller and the laser is switched off or the laser light is blocked. Preferably, the laser light is initially blocked and subsequently switched off. Preferably, the safety controller prompts blocking of the laser light, with the laser being provided and configured to detect the blocking of the laser light and subsequently switch off.

Preferably, the laser machining unit is provided and configured to transmit to the safety controller a laser power measured at the laser machining unit as parameter value. The laser light sent from the laser to the laser machining unit via the laser light cable is measured at the laser machining unit and the laser power is determined. The measured laser power is transmitted to the safety controller. If the measured laser power is greater than the limit value, then this is assessed as a violation of the limit value by the safety controller and the laser is switched off or the laser light is blocked.

Preferably, the laser is provided and configured to transmit to the safety controller a laser power set at the laser as parameter value. The laser sets its laser power on the basis of the laser power requested by the laser machining unit. For example, this setting is implemented in the form of the intensity of an electric current serving to create the laser light. The laser power set by the laser is transmitted from the laser to the safety controller. If the set laser power is greater than the limit value, then this is assessed as a violation of the limit value by the safety controller and the laser is switched off or the laser light is blocked.

Preferably, the laser is provided and configured to transmit to the safety controller a laser power measured at the laser as parameter value. The laser light created by the laser is measured at the laser and the laser power is determined. The measured laser power is transmitted to the safety controller. If the measured laser power is greater than the limit value, then this is assessed as a violation of the limit value by the safety controller and the laser is switched off or the laser light is blocked.

Preferably, the safety controller is provided and configured to compare a plurality of parameter values with a respective limit value. The safety is increased further by the comparison of a plurality of parameter values. In this case, the limit value can be the same or different. For example, the limit value may relate to a laser light power or to an electric current, set by the laser, for creating the laser light.

Preferably, the limit value corresponds to a protection value of a protective cabin of the laser machining installation. The protective cabin protects the laser machining installation operator from the laser light in the laser machining installation. The laser power should not become greater than the protection value of the protective cabin. The laser should be switched off or the laser light should be blocked if the laser power becomes greater than the protection value of the protective cabin. Monitoring the laser power is advantageous if the protection value of the protective cabin is less than a maximum possible laser power of the laser.

Preferably, a safety circuit is provided and configured to switch off the laser or block the laser light, the safety controller being communicatively connected to the safety circuit, the laser being switched off or the laser light being blocked by way of the safety circuit. A safety circuit is frequently installed in laser machining installations. For example, such a safety circuit can block the laser light or switch off the laser as soon as the protective cabin is opened. The safety controller is preferably communicatively connected to this safety circuit present.

Embodiments of the invention also provide a method for monitoring laser power, a laser sending a laser light via a laser light cable to a laser machining unit, the laser and/or the laser machining unit transmitting a parameter value relating to a laser power to a safety controller, the safety controller comparing the parameter value with a limit value, the safety controller prompting a switch-off of the laser or a blocking of the laser light emitted by the laser. The laser power is monitored by the method and a laser power that is too high is prevented at the laser machining unit.

Preferably, the parameter value is transmitted from the laser machining unit to the safety controller, the parameter value being, in particular, a requested laser power or a laser power measured at the laser machining unit. In an embodiment, the laser machining unit requests a laser power from the laser and transmits the value of the requested laser power to the safety controller. In an alternative or in addition, the laser machining unit is able to measure the laser power and transmit the value of the measured laser power to the safety controller.

Preferably, the limit value corresponds to a protection value of a protective cabin of the laser machining installation. The safety controller compares the parameter value with the protection value of the protective cabin and switches off the laser or blocks the laser light if the limit value is violated, i.e. if the parameter value is greater than the protection value of the protective cabin.

Preferably, the parameter value is transmitted from the laser to the safety controller, the parameter value being, in particular, a set laser power or a laser power measured at the laser. In an embodiment, the laser sets the laser power on the basis of the power requested. The laser power set by the laser is transmitted as parameter value to the safety controller. In an alternative or in addition, the laser measures the power of the emitted laser light and transmits the measured laser power as parameter value to the safety controller.

The following description of preferred embodiments serves to explain the invention in greater detail in association with the drawings.

Elements that are the same or have equivalent functions are denoted by the same reference signs in all the exemplary embodiments.

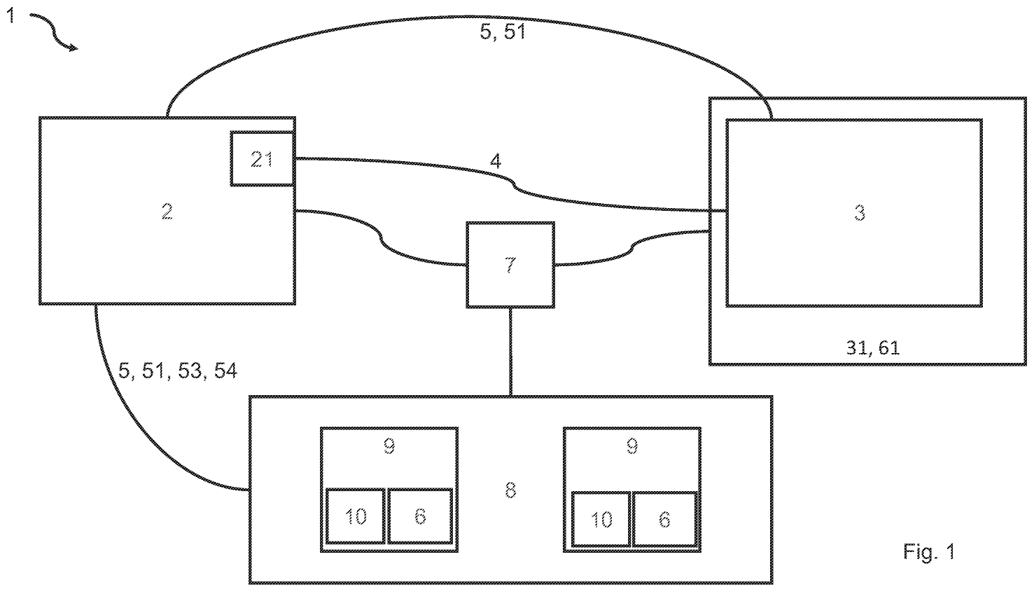

FIG. 1 shows a laser installation 1 according to an embodiment of the invention. The laser installation comprises a laser 2, a first laser machining unit 3, a first safety controller 8 and a first safety circuit 7. The laser 2 and the first laser machining unit 3 are communicatively coupled, via a data line in this example. The first laser machining unit 3 determines the required laser power and requests the laser power 51 from the laser 2 via the data line.

From the requested laser power 51, the laser 2 determines the electric current required and sets the laser power 53 in this way. Furthermore, the laser 2 measures the laser power 54 generated by means of a laser measuring unit 21. The laser light is then sent to the laser machining unit 3 via a laser light cable 4. The laser 2 sends as parameters relating to the laser power the requested laser power 51 received from the first laser machining unit 3, the set laser power 53 and the measured laser power 54 to the first safety controller 8.

The first laser machining installation 3 comprises a first protective cabin 31. The protective cabin prevents laser light from leaving the first laser machining installation 3 and thus protects humans in the vicinity of the first laser machining installation 3. The first protective cabin 31 is connected to the first safety circuit 7. As soon as the first protective cabin 31 is opened or any other safety risk in conjunction with the first protective cabin 31 is established, the first safety circuit 7, via a communicative connection to the laser 2, prompts the laser 2 to be switched off or the laser light to be blocked. The first protective cabin 31 has a first protection value 61, the protection value specifying the laser power up to which the first protective cabin 31 provides reliable protection.

In this example, the first safety controller 8 comprises two programmable logic controllers 9. As mentioned previously, FPGAs, ASICs, processors or other computing units are also possible in place of programmable logic controllers. The first protection value 61 of the first protective cabin 31 is permanently programmed as first limit value 6 in each programmable logic controller 9 of the first safety controller 8. Each programmable logic controller 9 comprises an execution unit 10. Each execution unit 10 compares the parameters 5 with the first limit value 6. The two programmable logic controllers 9 are configured to carry out a cross comparison of the results and thus identify a fault in one of the programmable logic controllers 9. The first safety controller 8 is communicatively connected to the first safety circuit 7. As soon as the first safety controller 8 establishes that a parameter 5 violates the first limit value 6, the first safety controller 8, via the first safety circuit 7, prompts the laser 2 to be switched off or the laser light to be blocked.

Attention is drawn to the fact that more or fewer parameters 5 that relate to the laser power can be used. Preferably, at least the measured laser power 54 is compared with the first limit value 6 by the safety controller. Preferably, the requested laser power 51 is also compared with the limit value 6 by the safety controller, in addition to the measured laser power 54. Preferably, the measured laser power 54 is checked vis-à-vis the first limit value 6 by an execution unit 10, and the requested laser power 51 is checked vis-à-vis the first limit value 6 by another execution unit 10.

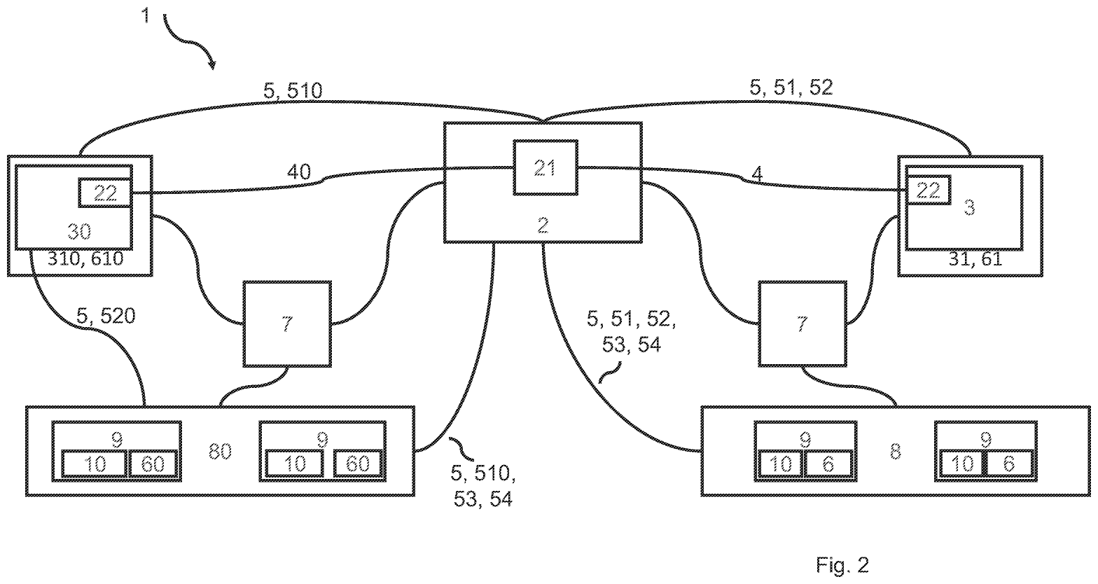

FIG. 2 shows a further laser installation 1 according to an embodiment of the invention. Only the differences in relation to FIG. 1 are described below. The laser 2 is connected to a second laser machining unit 30. The second laser machining unit 30 requests a second laser power 510 from the laser 2. If the laser 2 is not sending any laser light to the first laser machining unit 3, the laser 2 determines an electric current for generating the second requested laser power 510 from the second requested laser power 510, sets the laser power 53 accordingly and sends the laser light to the second laser machining unit 30 via a second laser light cable 40. The laser 2 sends as parameters relating to the laser power the requested laser power 510 received from the second laser machining unit 3, the set laser power 53 and the measured laser power 54 to the second safety controller 80. The second laser machining unit 30 uses a machining measuring unit 22 to measure the laser power 520 arriving via the second laser light cable 40 and sends the measured laser power 520 as the parameter relating to the laser power to the second safety controller 80. Should the laser 2 send laser light to the second laser machining unit 30 when the first laser machining unit 3 requests laser power, then the laser 2 sends laser light via the laser light cable 4 to the first laser machining unit 3 only once the second laser machining unit 30 no longer requests laser power. The first laser machining unit 3 uses a machining measuring unit 22 to measure the laser power 52 arriving via the first laser light cable 5 when the laser 2 sends laser light via the first laser light guide and sends the measured laser power 52 to the laser 2 via a data line, and the laser 2 sends the laser power 52 measured by the first machining unit 3 to the first safety controller 8 together with the other parameters 5.

The second laser machining installation 30 comprises a second protective cabin 310. The protective cabin prevents laser light from leaving the second laser machining installation 30 and thus protects humans in the vicinity of the second laser machining installation 30. The second protective cabin 310 is connected to a second safety circuit 7, with the second safety circuit by preference being constructed in exactly the same way as the first safety circuit 7. As soon as the second protective cabin 310 is opened or any other safety risk in conjunction with the second protective cabin 310 is established, the laser 2 is prompted to be switched off or the laser light is prompted to be blocked via a communicative connection to the laser 2. The second protective cabin 310 has a second protection value 610, the protection value specifying the laser power up to which the second protective cabin 310 provides reliable protection and possibly differing from the first protection value 61 of the first protective cabin 31. The safety circuit 7 is preferably connected into the communicative connection between laser processing unit 30 and laser 2.

In this example, the second safety controller 80 is constructed in exactly the same way as the first safety controller 8. The second protection value 610 of the second protective cabin 310 is permanently programmed as second limit value 60 in each programmable logic controller 9 of the second safety controller 80. The second safety controller 80 is communicatively connected to the second safety circuit 7. As soon as the second safety controller 80 establishes that a parameter 5 violates the second limit value 60, the second safety controller 80, via the second safety circuit 7, prompts the laser 2 to be switched off or the laser light to be blocked.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Laser installation
2 Laser
21 Laser measuring unit
22 Machining measuring unit
3, 30 Laser machining unit
4, 40 Laser light cable
5 Parameter value
51, 510 Requested laser power
52, 520 Measured laser power of the laser machining unit
53 Set laser power
54 Measured laser power of the laser
6, 60 Limit value
61, 610 Protection value
7, 70 Safety circuit
8, 80 Safety controller
9 Programmable logic controller
10 Execution unit
31, 310 Protective cabin

1. A laser installation comprising:
a laser,
a laser machining unit, and
a safety controller,
the laser being configured to provide laser light to the laser machining unit, wherein a laser power of the laser light is variable,
the safety controller being communicatively connected to the laser and the laser machining unit,
the laser and/or the laser machining unit being configured to transmit at least one parameter value relating to the laser power to the safety controller,
the safety controller being configured to:
compare the at least one parameter value with a limit value, and
turn off the laser or block the laser light upon determining that the at least one parameter value exceeds the limit value.

2. The laser installation according to claim 1, wherein the safety controller is designed redundantly in a form of two programmable logic controllers, each programmable logic controller configured to compare a respective parameter value with the limit value.

3. The laser installation according to claim 2, wherein the safety controller comprises a plurality of execution units configured for a cross comparison between the plurality of execution units.

4. The laser installation according to claim 1, wherein the safety controller comprises at least one programmable logic controller, and the limit value is permanently programmed in the at least one programmable logic controller.

5. The laser installation according to claim 1, wherein the laser machining unit is configured to transmit to the safety controller a requested laser power as the at least one parameter value.

6. The laser installation according to claim 1, wherein the laser machining unit is configured to transmit to the safety controller a laser power measured at the laser machining unit as the at least one parameter value.

7. The laser installation according to claim 1, wherein the laser is configured to transmit to the safety controller a laser power set at the laser as the at least one parameter value.

8. The laser installation according to claim 1, wherein the laser is configured to transmit to the safety controller a laser power measured at the laser as the at least one parameter value.

9. The laser installation according to claim 1, wherein the laser and/or the laser machining unit is configured to transmit a plurality of parameter values to the safety controller, and the safety controller is configured to compare each respective parameter value of the plurality of parameter values with a respective limit value.

10. The laser installation according to claim 1, wherein the limit value corresponds to a protection value of a protective cabin of the laser machining installation.

11. The laser installation according to claim 1, further comprising a safety circuit configured for switching off the laser or blocking the laser light,
wherein the safety controller is communicatively connected to the safety circuit.

12. A method for monitoring laser power in a laser installation, the method comprising:
sending laser light by a laser of the laser installation via a laser light cable to a laser machining unit of the laser installation,
transmitting, by the laser or the laser machining unit, a parameter value relating to a laser power of the laser light to a safety controller of the laser installation,
comparing, by the safety controller, the parameter value with a limit value,
upon determining that the parameter value exceeds the limit value, prompting, by the safety controller, a switch-off of the laser or a blocking of the laser light.

13. The method for monitoring laser power according to claim 12, wherein the parameter value is transmitted from the laser machining unit to the safety controller, the parameter value being a requested laser power or a laser power measured at the laser machining unit.

14. The method for monitoring laser power according to claim 13, wherein the limit value corresponds to a protection value of a protective cabin of the laser installation.

15. The method for monitoring laser power according to claim 12, wherein the parameter value is transmitted from the laser to the safety controller, the parameter value being a set laser power or a laser power measured at the laser.

16. The method for monitoring laser power according to claim 12, wherein the limit value corresponds to a protection value of a protective cabin of the laser installation.
